(19) United States
(12) Patent Application Publication
(10) Pub. No.: US 2014/0016260 A1
(43) Pub. Date: Jan. 16, 2014

(54) MOUNTING ASSEMBLY FOR DATA STORAGE DEVICES

(71) Applicants: Hon Hai Precision Industry Co., Ltd., New Taipei (TW); Hong Fu Jin Precision Industry (ShenZhen) Co., Ltd, Shenzhen (CN)

(72) Inventors: HUNG-CHIEH CHANG, New Taipei (TW); TANG-QING HU, Shenzhen (CN); LI-PING CHEN, New Taipei (TW)

(21) Appl. No.: 13/908,103

(22) Filed: Jun. 3, 2013

(30) Foreign Application Priority Data
Jul. 12, 2012 (CN) 201210240353X

(51) Int. Cl. G06F 1/16

(52) U.S. Cl. CPC G06F 1/16
USPC 361/679.32

(57) ABSTRACT

A mounting assembly includes a chassis, a baseboard mounted in the chassis, and a plurality of data storage devices received in the chassis. Each data storage devices includes a transfer circuit board, a transfer connector electrically connected to the transfer circuit board, and at least one data storage unit electrically connected to the transfer circuit board. The transfer connector is plugged to the baseboard.

### REFERENCE TO RELATED APPLICATIONS

This application claims all benefits accruing under 35 U.S.C. §119 from China Patent Application No. 201210240353.X filed on Jul. 12, 2012 in the State Intellectual Property Office of China, the contents of the China Application are hereby incorporated by reference.

### BACKGROUND

1. Technical Field

The present disclosure generally relates to mounting assemblies for data storage devices.

2. Description of Related Art

Data storage devices are installed in computers for communication and handling of data. Such devices include, for example, hard disk drives, floppy disk drives, and CD-ROM drives. A data storage device is conventionally attached to a computer enclosure with bolts. However, attaching the data storage device with bolts is complicated and time-consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is isometric view of an embodiment of a mounting assembly for data storage devices.

FIG. 2 is an exploded view of an embodiment of a data storage device.

FIG. 3 is similar to FIG. 2, but viewed from a different aspect.

FIG. 4 is similar to FIG. 3 with two data storage devices received in two drive brackets.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

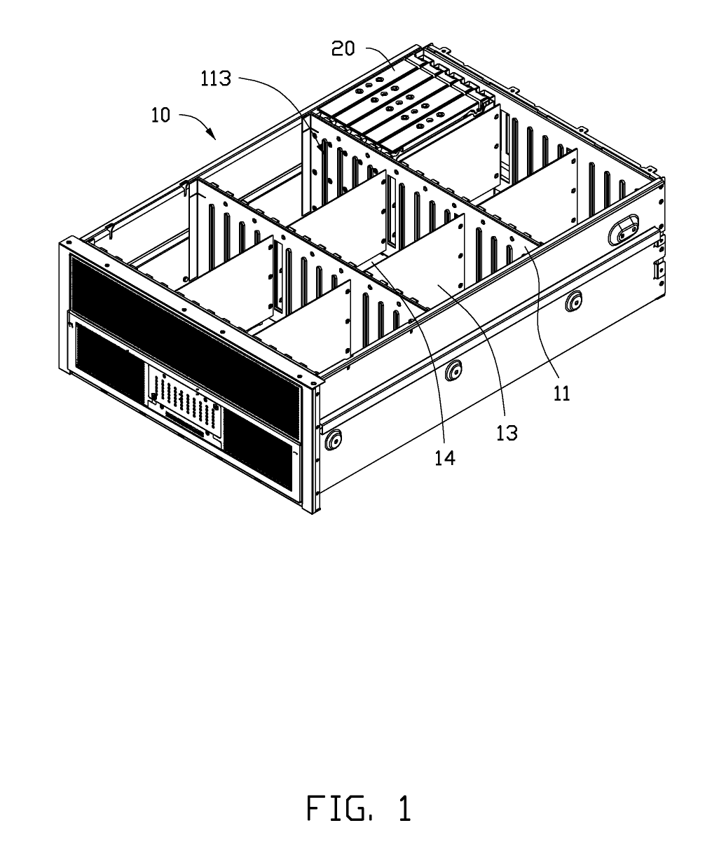

FIG. 1 shows a mounting assembly in accordance with an embodiment. The mounting assembly includes a chassis 10, a plurality of partition panels 11, a baseboard 14, and a plurality of data storage devices 20.

The plurality of partition panels 11 are mounted in the chassis 10. The plurality of partition panels 11 divides the space inside of the chassis 10 into a plurality of receiving spaces 13. In the embodiment of FIG. 1, each of the plurality of receiving spaces 13 can accommodate five data storage devices 20.

The baseboard 14 is attached to the chassis 10 below the plurality of partition panels 11. The plurality of partition panels 11 is substantially perpendicular to the baseboard 14.

Each of the plurality of partition panels 11 defines at least one elongated slot 113. The at least one elongated slot 113 is vertical and perpendicular to the baseboard 14.

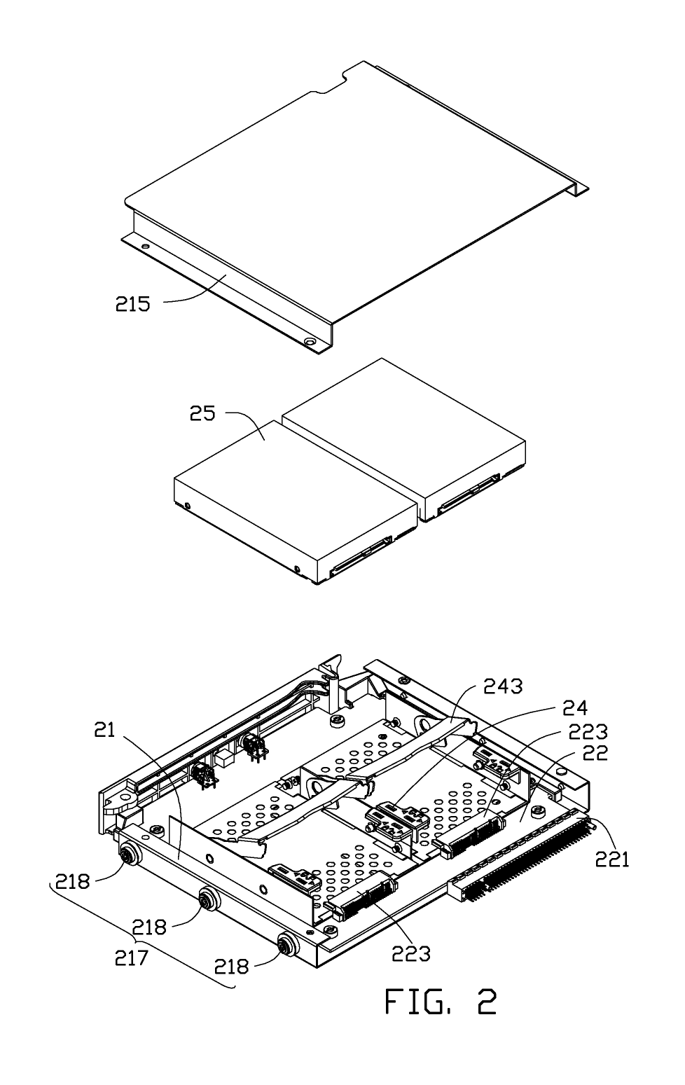

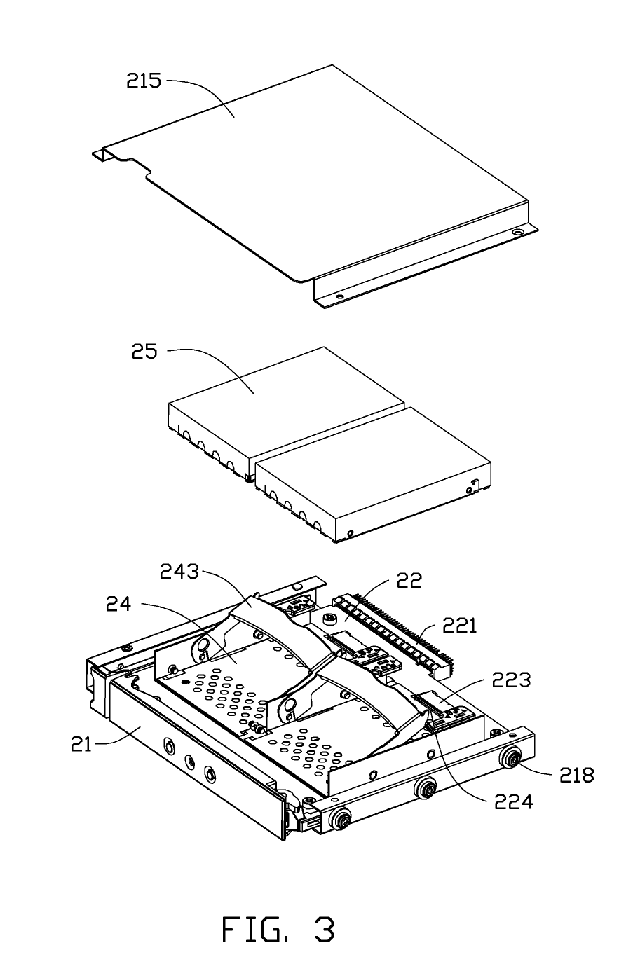

FIGS. 2-4 show a data storage device 20 in accordance with an embodiment. The data storage device 20 includes a casing 21, a cover 215, a transfer circuit board 22, a transfer connector 221, two storage connectors 223, two drive brackets 24, and two data storage units 25.

The transfer circuit board 22 is mounted in the casing 21. The transfer connector 221 is electrically connected to the transfer circuit board 22. In one embodiment, the transfer connector 221 is extended laterally from an edge of the transfer circuit board 22. The transfer connector 221 can be plugged to the baseboard 22.

The two storage connectors 223 are located on the transfer circuit board 22. The two storage connectors 223 are electrically connected to the transfer circuit board 22. Each of the two storage connectors 223 can be plugged to one of the two data storage units 25.

The two drive brackets 24 are mounted in the casing 21. Each of the two drive brackets 24 can receive one of the two data storage units 25.

The data storage device 20 further includes a guiding member 217. The guiding member 217 is located on a side surface of the casing 21. The guiding member 217 includes a plurality of cylindrical protrusions 218 aligned in a straight line. In some embodiments, an outer surface of each of the at least one cylindrical protrusion 218 is made of elastic material.

The data storage device 20 further includes two handles 243. The two handles 243 are rotatably attached to the two drive brackets 24.

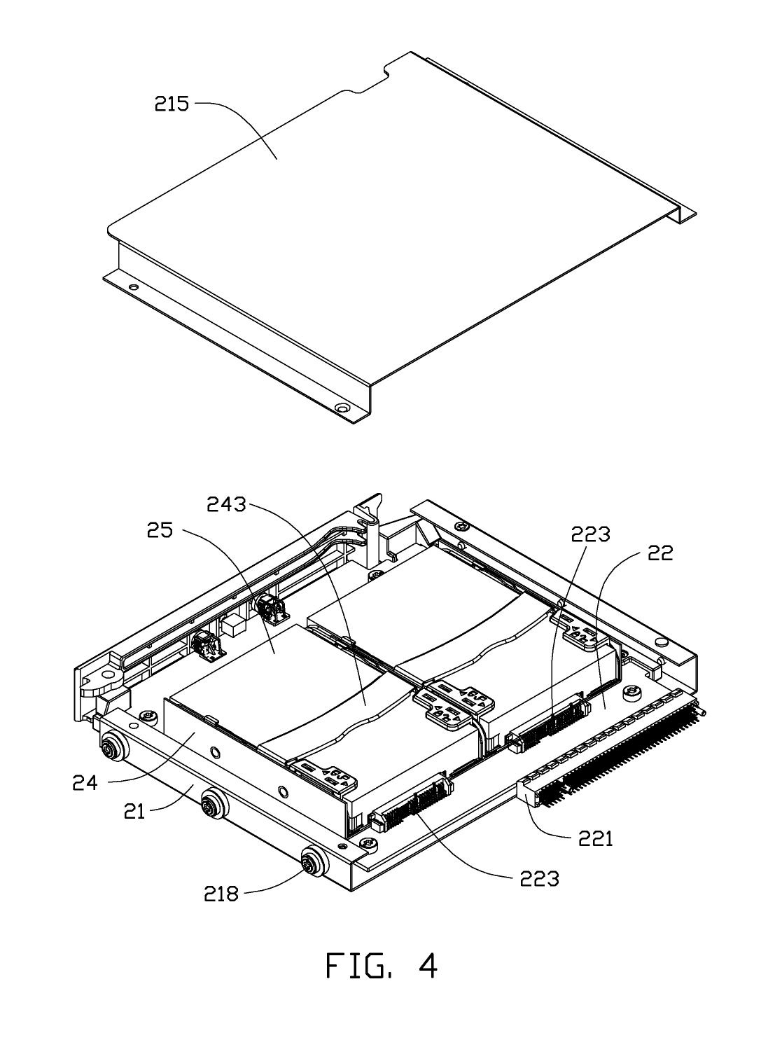

Referring to FIG. 4, in assembly, the two data storage units 25 are received in the two drive brackets 24. The two data storage units 25 are substantially parallel to the transfer circuit board 22. The bottom surface of each of the two data storage units 25 contacts the surface of the transfer circuit board 22. The two handles 243 are rotated downwardly to a locked position, where the two handles 243 abut top surfaces of the two data storage units 25 and are latched to the two drive brackets 24. Thus the two data storage units 25 are fixed in the two drive brackets 24 and prevented from moving from out of the two drive brackets 24. The cover 215 is then attached to the casing 21 and prevents the two data storage units 25 from moving out of the casing 21.

To remove the two data storage units 25 from the casing 21, the cover 215 is detached from the casing 21. The two handles 243 are rotated up to a released position from the locked position to disengage from the two drive brackets 24. The two data storage units 25 then can be removed from the two drive brackets 24 and the casing 21.

When the data storage device 20 is installed in the chassis 10, the guiding member 217 of the data storage device 20 slide into one of the at least one elongated slot 113 of the plurality of partition panels 11. The transfer connector 221 is plugged to a corresponding connector of the baseboard 14. The transfer circuit board 22 is substantially perpendicular to the baseboard 22.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting assembly comprising:
a chassis;
a baseboard mounted in the chassis; and
a plurality of data storage devices received in the chassis, each of the plurality of data storage devices comprising a transfer circuit board, a transfer connector electrically connected to the transfer circuit board, and at least one data storage unit electrically connected to the transfer circuit board, wherein the transfer connector is plugged to the baseboard.

2. The mounting assembly of claim 1, wherein the transfer connector is extended laterally from an edge of the transfer circuit board.

3. The mounting assembly of claim 2, wherein the transfer circuit board is substantially perpendicular to the baseboard.

4. The mounting assembly of claim 3, wherein each of the plurality of data storage devices comprises at least one storage connector located on the transfer circuit board and electrically connected to the transfer circuit board, and each of the at least one storage connector is configured to be plugged into one of the at least one data storage unit.

5. The mounting assembly of claim 4, wherein the at least one data storage unit is substantially parallel to the transfer circuit board.

6. The mounting assembly of claim 4, wherein a bottom surface of each of the at least one data storage unit contacts a top surface of the transfer circuit board, and the at least one storage connector is located on the top surface of the transfer circuit board.

7. The mounting assembly of claim 4, wherein each of the plurality of data storage devices further comprises a casing and a cover attached to the casing, and the transfer circuit board and the at least one data storage unit are mounted in the casing.

8. The mounting assembly of claim 7, further comprising a plurality of partition panels located in the chassis, wherein the plurality of partition panels divide the chassis into a plurality of receiving spaces, each of the plurality of receiving spaces is configured to receive at least one of the plurality of data storage devices.

9. The mounting assembly of claim 8, wherein each of the plurality of partition panels is substantially perpendicular to the baseboard.

10. The mounting assembly of claim 8, wherein each of the plurality of partition panels defines at least one elongated slot, each of the plurality of data storage devices further comprises a guiding member located on a side surface of the casing, and the guiding member is engaged with one of the at least one elongated slot.

11. The mounting assembly of claim 10, wherein the guiding member comprises a plurality of cylindrical protrusions aligned in a straight line.

12. The mounting assembly of claim 11, wherein an outer surface of each of the plurality of cylindrical protrusions is made of elastic material.

13. The mounting assembly of claim 7, wherein each of the plurality of data storage devices further comprises at least one drive bracket mounted in the casing and a handle rotatably attached to each of the at least one drive bracket, each of the at least one data storage unit is received in one of the at least one drive bracket, the handle is rotatable between a locked position, where the at least one data storage unit is not removable from the at least one drive bracket; and a released position, where the at least one data storage unit is removable from the at least one drive bracket.

14. A data storage device comprising:
a casing;
a drive bracket mounted in the casing;
a transfer circuit board mounted in the casing;
a data storage unit received in the drive bracket and electrically connected to the transfer circuit board;
a transfer connector electrically connected to the transfer circuit board and configured to be plugged into a baseboard; and
a handle rotatably attached to the drive bracket, wherein the handle is rotatable between a locked position, where data storage unit is not removable from the drive bracket; and a released position, where the data storage unit is removable from the drive bracket.

15. The data storage device of claim 14, wherein the transfer connector is extended laterally from an edge of the transfer circuit board.

16. The data storage device of claim 15, further comprising a storage connector located on the transfer circuit board and electrically connected to the transfer circuit board, the storage connector is configured to be plugged into the data storage unit.

17. The data storage device of claim 16, wherein the data storage unit is substantially parallel to the transfer circuit board.

18. The data storage device of claim 16, wherein a bottom surface of the data storage unit contacts a top surface of the transfer circuit board, and the data storage unit is located on the transfer circuit board.

19. The data storage device of claim 14, further comprising a cover attached to the casing thereby fixing the data storage unit in the casing.

20. The data storage device of claim 14, further comprising a guiding member located on a side surface of the casing, the guiding member comprising a plurality of cylindrical protrusions aligned in a straight line.
